(19) United States
(12) Patent Application Publication
(10) Pub. No.: US 2019/0130291 A1
(43) Pub. Date: May 2, 2019

(54) DYNAMIC RECONFIGURATION WITH PARTIALLY RESIDENT AGENTS

(71) Applicant: Wave Computing, Inc., Campbell, CA (US)

(72) Inventor: Christopher John Nicol, Campbell, CA (US)

(21) Appl. No.: 16/228,882

(22) Filed: Dec. 21, 2018

Related U.S. Application Data
(63) Continuation-in-part of application No. 16/170,268, filed on Oct. 25, 2018.
(60) Provisional application No. 62/773,486, filed on Nov. 30, 2018.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.

(51) Int. Cl. G06N 5/04; G06N 20/10

(52) U.S. Cl. CPC G06N 5/043; G06N 3/04; G06N 20/10

(57) ABSTRACT

Techniques are disclosed for dynamic reconfiguration with partially resident agents. A plurality of clusters on a reconfigurable fabric is accessed to implement a logical operation. Two or more clusters from the plurality of clusters are provisioned for implementation of a first agent on the reconfigurable fabric wherein the first agent is comprised of an agent control unit and an agent kernel. The logical operation is executed, on the two or more clusters of the reconfigurable fabric, using the first agent. The agent kernel is removed from the reconfigurable fabric while leaving the agent control unit resident on the reconfigurable fabric. The agent control unit is further used to buffer data incoming to the first agent. The agent control unit is further used to provide data to logic downstream from the first agent. A second agent provides data incoming to the first agent.

### RELATED APPLICATIONS

This application claims the benefit of U.S. provisional patent applications “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, and “Reconfigurable Fabric Configuration Using Spatial and Temporal Routing” Ser. No. 62/773,486, filed Nov. 30, 2018.

This application is also a continuation-in-part of U.S. patent application “Tensor Manipulation Within a Neural Network” Ser. No. 16/170,268, filed Oct. 25, 2018, which claims the benefit of U.S. provisional patent applications “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to calculation and more particularly to dynamic reconfiguration with partially resident agents.

### BACKGROUND

Data is collected by businesses, governments, and researchers to meet objectives such as learning, prediction, surveillance, and tracking. Data collection results in massive datasets which continuously expand. The collected datasets, called “big data,” deliver significant data processing challenges due to the sheer volume of the data. While the data handling and processing challenges may appear daunting, the agencies that collect the data are highly motivated to extract value from the data for many commercial, research, and security purposes. A variety of tasks are performed to accomplish these purposes. The tasks typically include learning, marketing, and predicting, among many others. The processors, integrated circuits, and other computing hardware used to perform the data processing techniques present a further complication to data processing because the traditional architectures, processors, and algorithms cannot process and analyze the massive datasets. Processing the datasets becomes impossible because the requested analysis consumes all available computational capabilities of the conventional architectures and techniques. Further, the analysis, capture, maintenance, storage, transmission, visualization, and so on, of the data, saturate the processing and handling capabilities of the traditional systems. The data would be of little or no value if there were no way to process the data efficiently. Instead, new processing hardware such as advanced computer chips and architectures, and software such as algorithms, heuristics, functions, and so on, are required.

The organizations holding the datasets or that have access to the datasets perform a vast variety of analyses on the data contained in the datasets. Common analysis purposes include business analysis; complex science and engineering simulations; crime detection and prevention; disease detection, tracking, and control; and meteorology; among many others. Advanced data analysis techniques such as predictive analytics are showing promise for these applications. These techniques can extract value from the datasets for business and other entities. Other uses for the datasets often include machine learning and deep learning.

Computational metrics and other metrics can be used to measure the data processing performance of hardware and software. The metrics can include values, percentages, a range of values, pass or fail, and so on. The metrics can include high throughput such as high data throughput, fast data processing response time, low computational resources utilization, and so on. Performance can also be based on other criteria such as high data bandwidth, high hardware availability, efficient data storage and transfer, among others. System, hardware, and software design techniques have been developed to address these and other design issues. These design issues are encountered while a data processing technique is being developed. An approach called “performance engineering” has been developed for system design. Performance engineering seeks to examine the many design tradeoffs. The design tradeoffs can include determining which performance requirements can be met and at what cost by proposed architectures. Further, the design tradeoffs can be used to determine which functions should be implemented in hardware and which functions should be implemented in software. The principal performance engineering objective is to meet the design performance requirements while maintaining or minimally impacting other system performance metrics. The result of the design process, when executed properly, is a high-performance design that minimizes both cost and the use of computational resources.

### SUMMARY

Architectures can be implemented to support reconfigurable computing which incorporates circuit techniques and coding techniques. The hardware within the reconfigurable architectures is efficiently designed and is capable of high performance when compared to the performance of general purpose hardware. Further, these reconfigurable architectures can be adapted using techniques similar to those used to modify software. That is, the reconfigurable architecture can be adapted by changing the code used to configure the architecture. A reconfigurable fabric is one such architecture used for reconfigurable computing. Reconfigurable fabrics can be arranged in a variety of topologies, where the topologies are coded to perform many applications that require high performance computing. Applications such as data processing, digital signal processing (DSP), neural networks, such as convolutional neural networks (CNN) and deep neural networks (DNN), and so on, are well served by the capabilities of a reconfigurable fabric.

Reconfigurable fabrics perform particularly well when handling specific types of data, large quantities of unstructured data, and so on. The reconfigurable fabrics can be configured by coding, or scheduling, to execute these and other processing techniques in a manner that works smoothly and cohesively. The scheduling can include agents, where the agents can be used for performing operations such as logical operations. Further, the reconfigurable fabric can be scheduled to configure a variety of computer architectures that can perform various types of computations with high efficiency. The scheduling of the reconfigurable fabric can be changed based on a flow graph when the number of tasks to be performed outstrips the number of clusters of processing elements available in the reconfigurable fabric. The flow graph can enable dynamic reconfiguration with partially resident agents.

Calculation is performed within a reconfigurable fabric using dynamic reconfiguration with partially resident agents. The agents are comprised of an agent control unit and an agent kernel. The reconfigurable fabric includes a variety of elements such as processing elements, communications capabilities, storage elements, switching elements, and so on. Clusters of elements on the reconfigurable fabric can be provisioned for implementation of an agent. Embodiments include a processor-implemented method for computation comprising: accessing a plurality of clusters on a reconfigurable fabric to implement a logical operation; provisioning two or more clusters from the plurality of clusters for implementation of a first agent on the reconfigurable fabric wherein the first agent is comprised of an agent control unit and an agent kernel; executing, on the two or more clusters of the reconfigurable fabric, the logical operation using the first agent; and removing the agent kernel from the reconfigurable fabric while leaving the agent control unit resident on the reconfigurable fabric.

Some embodiments comprise using the agent control unit to buffer data incoming to the first agent. In embodiments, a second agent provides the data incoming to the first agent. Some embodiments comprise removing a portion of the second agent. Some embodiments further comprise using the agent control unit to provide data to logic downstream from the first agent.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for dynamic reconfiguration of data flow agents.

FIG. 2 is a flow diagram for agent handling.

FIG. 3 is an example showing an agent template with kernel and control.

FIG. 4 is a flow diagram for subgraph swapping.

FIG. 5A is an example illustrating swapping out a subgraph.

FIG. 5B is an example illustrating agent 1 partially resident.

FIG. 5C is an example illustrating agent 2 partially resident.

FIG. 5D is an example illustrating a swapped-out subgraph.

FIG. 6 shows a deep learning block diagram.

FIG. 7 shows a cluster for coarse-grained reconfigurable processing.

FIG. 8 illustrates a block diagram of a circular buffer.

FIG. 9 illustrates a circular buffer and processing elements.

FIG. 10 is a system diagram for dynamic reconfiguration with partially resident agents.

### DETAILED DESCRIPTION

Techniques are disclosed for dynamic reconfiguration with partially resident agents. Agents are computer programs that can act on behalf of an individual or for another program. The software agents can take actions within an environment. As the agents take actions, they attempt to maximize some kind of a goal or objective. The actions taken by the agents can include a “cumulative reward”, where the highest reward wins. In order for an agent to be able to take actions, the software agent is implied to have the authority to act on behalf of the individual or the other program. The actions taken are decided by a technique such as action selection to determine what action should be taken next. One example of the use of agents is in performing logical operations. The agents can be used to decide both which logical operations can be taken and the order in which the operations are taken. The environment in which agents act can be modeled using a mathematical framework such as a Markov decision process or MDP. The mathematical framework of the MDP models decision making within the environment. The decisions taken within the environment are partly under the control of the decision maker and partly stochastic (random). The environment in which the agents act can be provisioned on a data flow processor, where the data flow processor can be implemented within a reconfigurable fabric.

A reconfigurable fabric can include one or more types of elements. The elements can be configured to perform a variety of architectural and computational tasks, based on the type of element. The elements can be configured as processing elements, storage elements, switching elements, and so on. The reconfigurable fabric can include clusters or quads of elements, where the quads can include processing elements, shared storage elements, switching elements, circular buffers for control, communications paths, and the like. An element within the reconfigurable fabric can be controlled by providing code, where the code configures the element as a processing element, switching element, storage element, etc. Code can also be provided to a plurality of elements within the reconfigurable fabric so that the reconfigurable fabric can execute various computational tasks such as performing logical operations using agents.

The various elements of the reconfigurable fabric can be controlled using one or more rotating circular buffers. Functions, algorithms, instructions, codes, etc., can be loaded into a given circular buffer. The providing of the instructions to the rotating circular buffer can be imagined as scheduling the elements controlled by the circular buffer for a specific set of tasks. The performing tasks can include executing the logical operations using agents. The one or more circular buffers can be of the same lengths or differing lengths. The rotation of the circular buffer ensures that the same series of steps or instructions is repeated for as long and as frequently as required by the processing tasks assigned to a processing element of the reconfigurable fabric. The one or more rotating circular buffers can be statically scheduled. Static scheduling involves loading the circular buffers during non-run time in a manner that ensures all of the processing tasks are conducted harmoniously and without contention. Statically scheduled circular buffers can support runtime functionality changes by means of rotating the code at a runtime, dynamic frequency. Static scheduling with runtime functionality changes is very different from the programming of an FPGA, which is completed only once upon device reset and locks in the functionality until a subsequent power-cycle or code reset/reload.

A sophisticated means of runtime functionality change enhancement is called dynamic reconfiguration. Dynamic reconfiguration is performed with partially resident agents. The agents can be used for performing, or executing, logical operations. The dynamic reconfiguration can be applied to provisioning pluralities of clusters within a reconfigurable fabric. A plurality of clusters is accessed on a reconfigurable fabric to implement a logical operation. Two or more clusters from the plurality of clusters are provisioned for implementation of a first agent on the reconfigurable fabric wherein the first agent is comprised of an agent control unit and an agent kernel. The logical operation is performed, or executed, using the first agent. The agent kernel is removed from the reconfigurable fabric while leaving the agent control unit resident on the reconfigurable fabric. The agent control unit can have a variety of applications. The agent control unit is used to buffer data incoming to the first agent, where a second agent provides the data incoming to the first agent. The agent control unit is used to provide data to logic downstream from the first agent. The agent control unit maintains data structures within the reconfigurable fabric. The agent can be partially resident by having the agent control unit resident after the agent kernel is removed. Having both the agent control unit and the agent kernel resident comprises having the agent fully resident. The removing of both the agent control unit that is resident and the agent kernel results in having the agent fully vacant. Removing the agent control units only occurs once the output buffers from the agent are empty. Further, the removing the agent control unit only occurs once input buffers to the agent are empty. A further agent can be loaded once the space is vacated after removing the agent kernel.

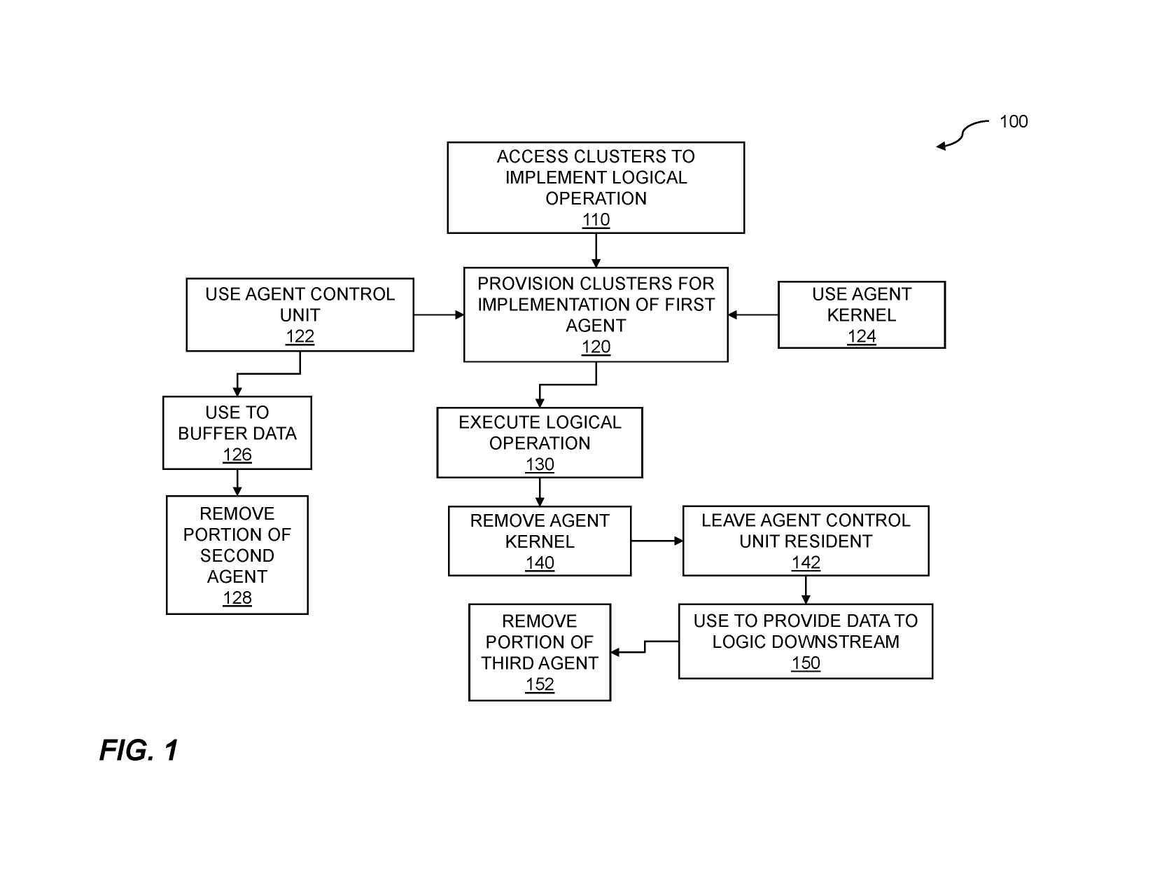

FIG. 1 is a flow diagram for dynamic reconfiguration of data flow agents. The flow 100 includes accessing a plurality of clusters on a reconfigurable fabric to implement a logical operation 110. The reconfigurable fabric can include elements such as processing elements, switching elements, storage elements, and so on. The elements, such as processing elements, can be organized in quads. The quads can include the processing elements such as four processing elements, one or more rotating circular buffers which can be used for control, storage elements located between and around the processing elements, etc. The quads can be formed into clusters of one or more quads. The flow 100 includes provisioning two or more clusters from the plurality of clusters for implementation of a first agent 120 on the reconfigurable fabric. The plurality of clusters can be adjacent clusters, where the clusters can include quads. In embodiments, each cluster from the plurality of clusters can include a plurality of processing elements. The first agent is formed by using an agent control unit 122 and an agent kernel 124. The agent control unit can send and receive control signals, handle streams of input data and output data, manage and control data buffers, and so on. The agent control unit can be provisioned with clusters separate from the clusters provisioned for the agent kernel. In embodiments, the agent control unit can be contained within a single cluster from the plurality of clusters.

Further embodiments include using the agent control unit to buffer data 126 incoming to the first agent. The data that is incoming to the first agent can include data, tensor data, tensor metadata, and the like. The incoming data can be sourced from another agent; from a memory, register, register files, etc., within the reconfigurable fabric; from memory such as direct memory access (DMA) structures external to the reconfigurable fabric; and so. In embodiments, a second agent provides the data incoming to the first agent. The second agent can be another agent from a data flow graph of which the first agent is a part. The second agent can hold data in an output buffer accessible to the first agent. The first agent can consume the data from the output buffer of the second agent until the buffer is drained. When the output buffer of the second agent is drained, portions of or all of the second agent are eligible for removal from the reconfigurable fabric. The flow 100 further includes removing a portion of the second agent 128. The portion of the second agent that can be removed can include the agent kernel, the agent control unit, etc.

The flow 100 includes executing the logical operation 130 using the first agent. The first agent can perform logical operations such as AND, NAND, OR, NOR, XOR, XNOR, NOT (invert), and so on. The first agent can perform tensor operations, where the tensor operations can include computing tensor product or tensor contraction, raising a tensor index, lowering a tensor index, and so on. The flow 100 includes removing the agent kernel 140 from the reconfigurable fabric. The removing the agent kernel can be accomplished by freeing the clusters to which the agent kernel was assigned. The flow 100 includes leaving the agent control unit resident 142 on the reconfigurable fabric. The leaving the agent control unit resident can support buffering of data, as mentioned above. The leaving the agent control unit resident can enable processing and generating of control signals such as fire signals and done signals. The flow 100 includes using the agent control unit to provide data to logic downstream 150 from the first agent. The providing data to the downstream logic can include sending one or more fire signals to the downstream logic, waiting for one or more done signals to return from the downstream logic, waiting for the output buffer of the first agent to drain, and so on. In embodiments, a third agent can be included in the logic downstream from the first agent. Other agents can also be included in the logic downstream from the first agent. Recall that removing a portion of an agent can be dependent on the draining of an input buffer to the agent. The third agent can drain the output buffer of the first agent. Further embodiments include removing a portion of the third agent 152. The portion of the third agent that can be removed can include the third agent kernel, the third agent control unit, or both. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

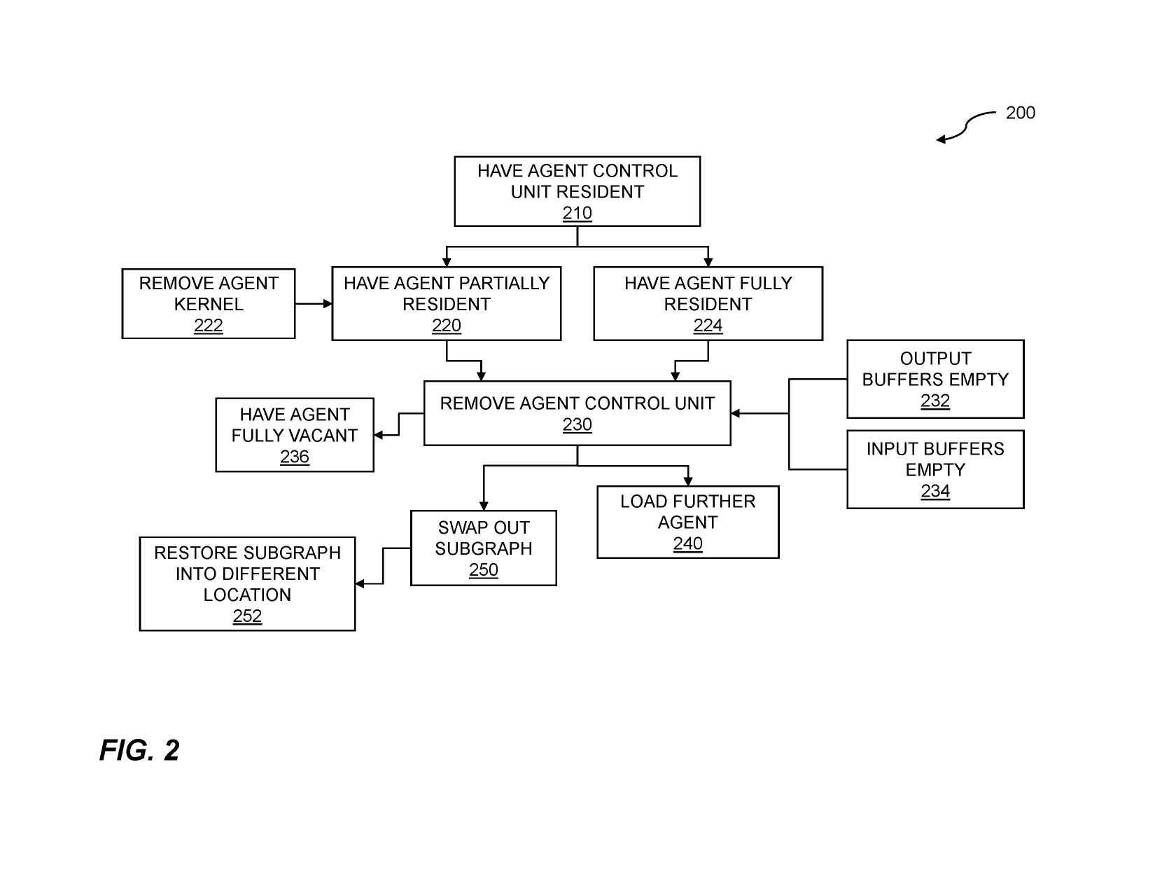

FIG. 2 is a flow diagram for agent handling. Agents can be loaded into a reconfigurable fabric in order to process a data flow graph, or other technique, for processing data such as tensors. The processing can include handling the agents, where the handling of agents can include loading agents, removing portions of agents, fully removing agents, and so on. The agent handling can support dynamic reconfiguration with partially resident agents. The flow 200 includes having an agent control unit resident 210 within a reconfigurable fabric. The agent control unit can be part of an agent template described below, where an agent template includes an agent control unit and an agent kernel. The agent control unit can control the agent kernel, handle data input and data output, manage input buffers and output buffers, and so on. The flow 200 includes having the agent control unit partially resident 220 after an agent kernel is removed 222. Having the agent control unit resident after the agent kernel is removed comprises having the agent partially resident. The agent kernel can be removed from the reconfigurable fabric to free up processing elements in the reconfigurable fabric. The agent kernel can be removed when the agent kernel has drained input buffers that provide data to the agent kernel, and the output buffers fed by the agent kernel have been drained. The flow 200 can include having the agent control unit and the agent kernel resident within the reconfigurable fabric. Having both the agent control unit and the agent kernel resident comprises having the agent fully resident 224. The agent control and the agent kernel can remain loaded within the reconfigurable fabric while processing data such as tensor, awaiting data, and so on.

The flow 200 includes removing the agent control unit 230. The agent kernel can be removed from the reconfigurable fabric to free up processing elements, quads of processing elements, switching elements, storage elements, and so on. In embodiments, the removing the agent control unit resident as well as having the agent kernel removed comprises having the agent fully vacant 236. The removing the agent control unit can be based on data that is processed by the agent. In embodiments, the removing the agent control unit only occurs once output buffers from the agent are empty 232. The agent control unit controls data flowing into its one or more output buffers. The control of the output buffers includes ensuring that one or more agents downstream from the agent have drained all data from the one or more output buffers. In embodiments, the removing the agent control unit only occurs once input buffers to the agent are empty 234. The agent can process input data until the data in the input has been drained.

The flow 200 includes loading a further agent using space vacated by the removing the agent kernel 240. The further agent can be an agent from a plurality of agents that are part of the data flow graph. Two or more clusters on the reconfigurable fabric can be provisioned for implementation of the further agent on the reconfigurable fabric. The further agent can include an agent control unit and an agent kernel. The flow 200 includes the removing the agent kernel by swapping out a subgraph 250 that is part of the data flow graph. The swapping out the subgraph can occur once output buffers from the agents of the subgraph are empty. The swapping out the subgraph further can occur once input buffers to the agents of the subgraph are empty. In embodiments, the subgraph can be restored into the reconfigurable fabric. The flow 200 includes restoring the subgraph, where the restoring places the subgraph into a different location 252 in the reconfigurable fabric than previously occupied by the subgraph prior to the swapping out of the subgraph. The restoring the subgraph into a different location can be based on availability of clusters within the reconfigurable fabric. The restoring the subgraph can also include restoring the subgraph into the same location previously occupied by the subgraph. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

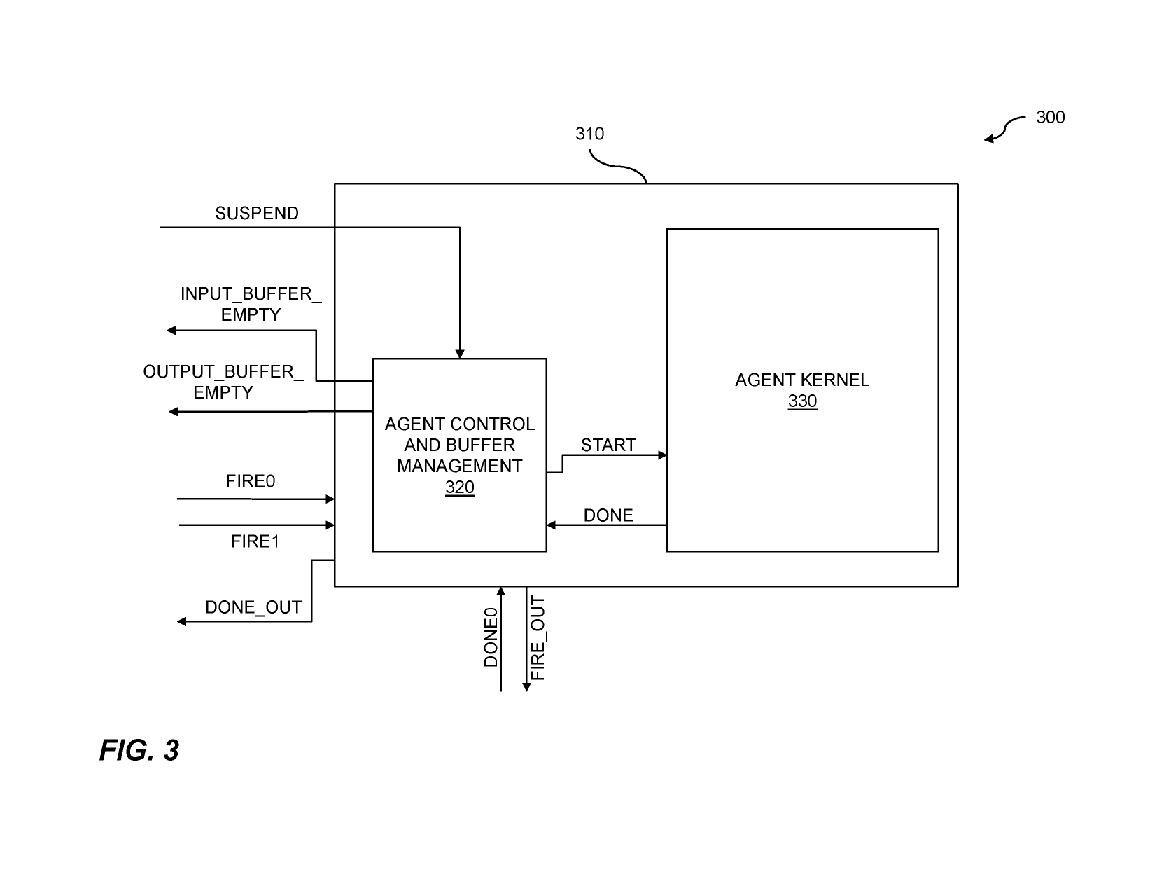

FIG. 3 is an example showing an agent template 300 with kernel and control. An agent template can be used as a basis for an agent, where an agent can take actions on behalf of a program, a process, a function, or an individual, etc. The agent 310 can work alone or in cooperation with a plurality of agents. The one or more agents can participate in dynamic reconfiguration of a reconfigurable fabric, where the agents can be partially resident. An agent can include control signals, where the control signals can be received from other agents, a host controller, instructions from a data flow graph, instructions from a rotating circular buffer, and so on. The control signals can include fire signals, such as fire0, fire1, etc., where the fire signals can indicate that data is ready for processing by the agent 310. The control signals can also include one or more done signals such as done0, where done0 can indicate that another agent has completed processing of data for a source such as an output buffer. The agent can produce one or more output signals such as a done_out signal, fire_out, etc. The fire_out signal can indicate that data in an output buffer is ready for processing. An agent template can include agent control and buffer management 320. Agent control and buffer management, also referred to herein as agent control, can interface with upstream and downstream agents. Agent control can address memories external to the reconfigurable fabric, can request data transfers such as direct memory access (DMA) transfers from input and output buffers, etc. The transfers can transfer data such as tensors stored in external memory to the local data memories. The agent control can manage one or more buffers, where the buffers can include an input buffer, and output buffer, etc. To communicate with other agents, agent control 320 can include one or more control signals. The control signals can include input signals and output signals, where the input and output signals can include signals within the reconfigurable fabric. The input signals can include suspend, done, and so on. The output signals can include input_buffer_empty, output_buffer_empty, etc. Agent control can also include input signals and output signals for controlling an agent kernel 330. The output signal can include start, to indicate that the agent kernel may start processing data such as tensor data. The input signal can include done, to indicate that the agent kernel has completed processing data. The agent kernel can include processing for the agent. The processing for the agent can perform logical operations such as AND, OR, NAND, NOR, XOR, XNOR, and the like. The processing can include matrix operations.

The reconfigurable fabric can include elements such as processing elements, switching elements, storage elements, and the like. Processing to be performed on the reconfigurable fabric can be described by a data flow graph. The data flow graph to be processed on the reconfigurable fabric may be larger than the reconfigurable fabric. In embodiments, the data flow graph can exceed the capacity of the reconfigurable fabric for a single loading. In this case, agents can be time multiplexed in being loaded into the reconfigurable fabric. Dynamic reconfiguration can be used for scheduling and loading the agents. Within the reconfigurable fabric, the agents can be fully resident, partially resident, or fully vacant. An agent that is fully resident can include both its control block and its kernel being loaded within the reconfigurable fabric. An agent that is partially resident can have its control unit resident within the reconfigurable fabric and its kernel swapped out of the reconfigurable fabric. A fully vacant agent can have both its control unit and its kernel swapped out of the reconfigurable fabric.

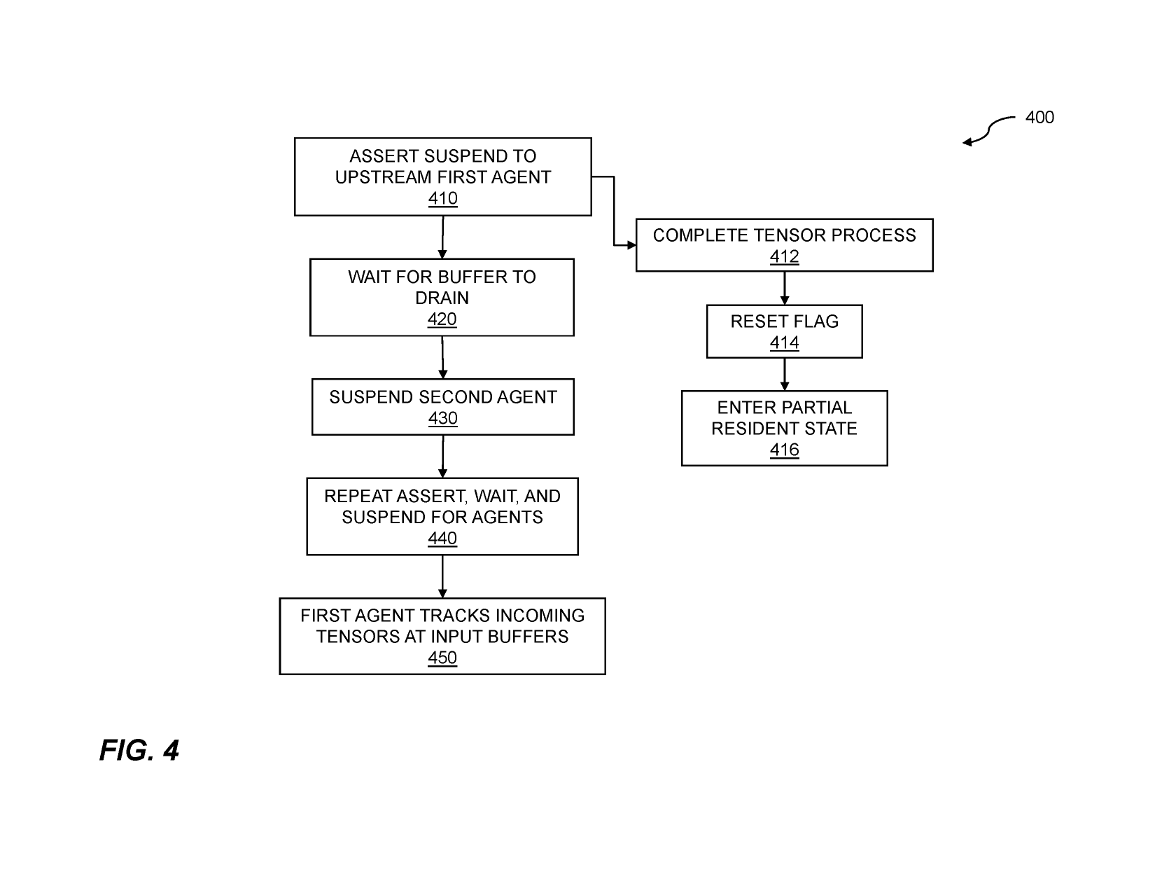

FIG. 4 is a flow diagram for subgraph swapping. An agent, such as the agents discussed above, can be part of a data flow graph implemented within the reconfigurable fabric. The data flow graph can represent a computational task such as digital signal processing, analysis of large datasets, tensor analysis, and so on. The data flow graph can exceed the capacity of the reconfigurable fabric for a single loading, necessitating that some agents be swapped out of the reconfigurable fabric, and other agents can be swapped in. The swapping of agents supports dynamic reconfiguration with partially resident agents. The flow 400 includes asserting a suspend signal to an upstream first agent 410. The suspend signal can be executed from a rotating circular buffer. The suspend signal can be a semaphore, a streaming input control signal, etc. Before a suspend signal can be responded to, the first agent can complete an operation. The suspend signal can be asserted to halt operation of the upstream first agent so that a second agent can process data from an output buffer fed by the first agent. In embodiments, the first agent completes a tensor process 412. The tensor process can include a tensor operation, where the tensor operations can include computing tensor product, tensor contraction, raising a tensor index, lowering a tensor index, and so on. Upon completion of the tensor process, a flag can be reset 414. The flag that can be reset can include an “in use” flag indicating that the agent is processing data from a buffer. The flag can include a done flag. In embodiments, the flow 400 includes entering a partially resident state 416. The removal of an agent kernel from the reconfigurable fabric can be accomplished while leaving the agent control unit resident in the reconfigurable fabric. In embodiments, having the agent control unit resident after the agent kernel is removed can include having the agent partially resident. The agent that remains partially resident can include a first agent, a second agent, a third agent, or other agents.

The flow 400 includes waiting for a buffer to drain 420. An agent such as a second agent can process input data from one or more buffers and can produce output data to one or more buffers. The operation of the agent continues until the contents of the input buffers have been exhausted (the input buffers drained) and the output data stored in the output buffers has been consumed (emptied) by a downstream agent. In embodiments, the removing the agent control unit can only occur once input buffers to the agent are empty. In a similar manner, the removing the agent control unit can only occur once output buffers from the agent are empty. The input and output buffers can include registers, register files, first in first out (FIFO) structures, and so on. The flow 400 includes suspending a second agent 430. The suspending the second agent can occur based on both an input buffer and an output buffer being empty. A suspended second agent can remain within the reconfigurable fabric, can be partially removed, or can be fully removed. In embodiments, an agent remaining within the reconfigurable fabric can be fully resident, an agent partly remaining within the reconfigurable fabric can be partially resident, and an agent fully removed from the reconfigurable fabric can be fully vacant.

The flow 400 includes repeating assert, wait, and suspend for agents 440 within the reconfigurable fabric. In embodiments, a suspended semaphore can be asserted by runtime software (SW). The runtime SW asserts the semaphore to commence dynamic reconfiguration of the reconfigurable fabric. A wait signal can be asserted to indicate that an agent can wait for processing to complete, for a buffer to empty, and so on. A suspend can be issued to suspend operation of the agent, where the agent can be an upstream agent. The flow 400 includes the first agent tracking incoming tensors at input buffers 450. The first agent can be partially resident. The tracing incoming tensors can include examining input buffers for data arriving from upstream sources such as agents. Various steps in the flow 400 may be changed in order, repeated, omitted, or the like without departing from the disclosed concepts. Various embodiments of the flow 400 can be included in a computer program product embodied in a non-transitory computer readable medium that includes code executable by one or more processors.

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a sleeping control unit. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor that is being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to fully vacate because a fire signal might be sent to the agent by the upstream agent. When the upstream agent is partially resident or is fully vacant, then the agent can be fully vacated from the reconfigurable fabric. The agent can be fully vacated if it asserts that both the input buffers empty and output buffers empty signals are engaged.

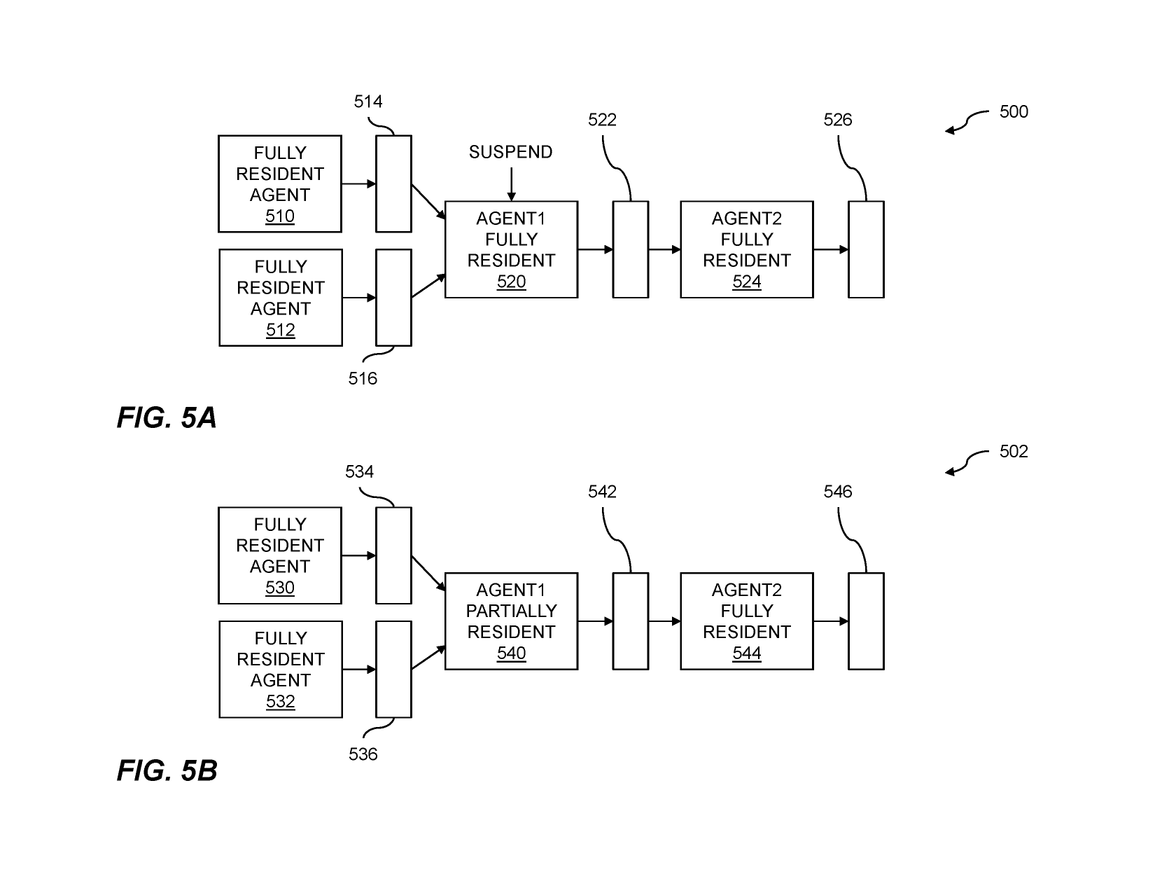

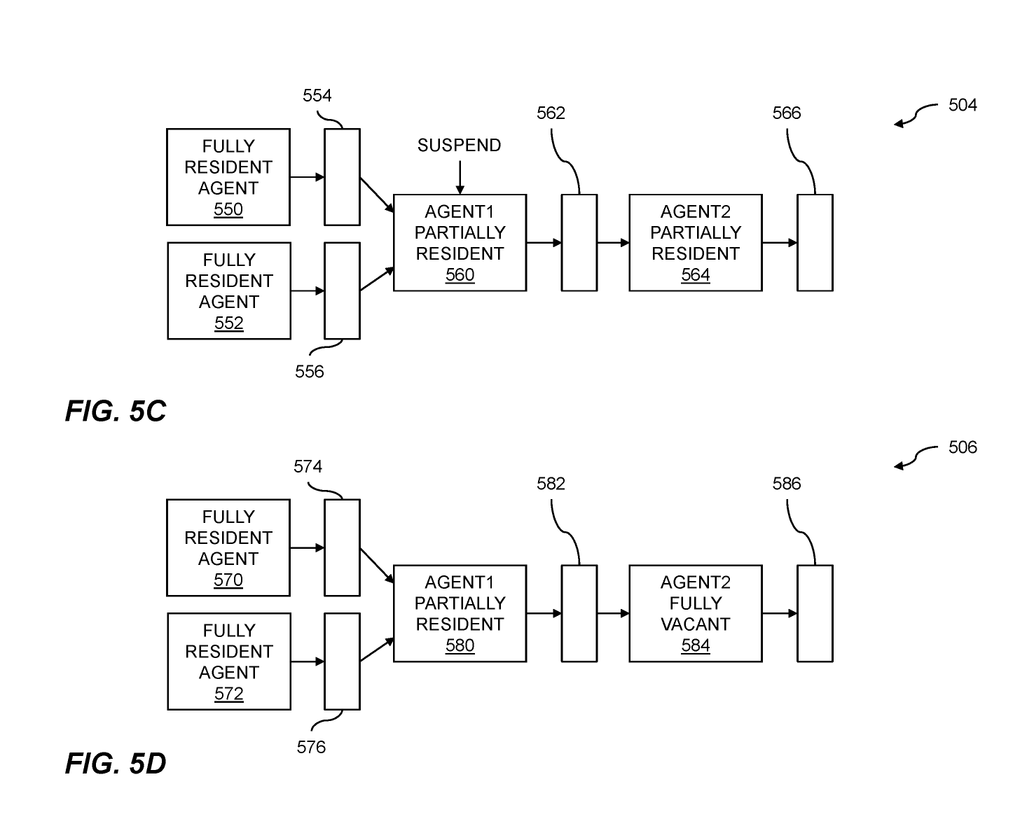

FIG. 5A is an example illustrating swapping out a subgraph 500. A data flow graph can include one or more subgraphs, where the subgraphs can include one or more agents. Subgraphs can be swapped into a reconfigurable fabric and swapped out of a reconfigurable fabric based on processing data. Subgraphs that are swapped out can be restored into the reconfigurable fabric. The processing data can include logical operations, tensor operations, and so on. The swapping out of a subgraph can support dynamic reconfiguration with partially resident agents. The swapping out of a subgraph can include waiting for a pipeline of agents to complete processing of data being provided to agents within the pipeline. The swapping out of a subgraph can be controlled by runtime or host software.

A first fully resident agent 510 can provide data to an output buffer 514 which can serve as an input to agent 1. Agent 1 is fully resident 520. A second fully resident agent 512 can provide data to an output buffer 516, where the output buffer 516 serves as an input to agent 1. The runtime software can assert a suspend signal input to agent 1. The runtime software can be in communication with a host interface. The host interface can perform various operations on an agent such as initialization, restart, pause, run, and so on. Agent 1 can prepare to place itself into a partially resident state. In a partially resident state, the agent 1 kernel can be removed. Agent 1 can wait for data presently in its output buffers 522 to be drained, thereby completing processing. Agent 1 stops loading data into its input buffers, and resets a signal such as a semaphore, flag, or other signal. The reset signal is sent back to the runtime software to indicate that agent 1 has entered a partially resident state. The runtime software can remove the agent kernel from the upstream agent 1. The output buffer 522 from agent 1 can be used as an input to agent 2. Agent 2 can be fully resident 524. Agent 2 can provide data to and can control an output buffer 526. The output buffer can be used as an input buffer to another agent downstream (not shown) from agent 2. Agent 2 processing continues until its input buffer, output buffer 522 for agent 1, is drained.

FIG. 5B is an example illustrating partially resident agent 1 502. As described above, agent 1 can be placed into a partially resident state based on receiving a suspend signal from runtime software. A first fully resident agent 530 can provide data to output buffer 534. The output buffer 534 contains data that can be drained by agent 1. A second fully resident agent 532 can provide data to output buffer 536. As for the other input to agent 1, the output buffer 536 contains data that can be drained by agent 1. Agent 1 can be partially resident, which can result from the agent receiving a suspend signal from the runtime software. The upstream agent 1 waits for its output buffer 542 to drain. When the agent 1 output buffer has been drained, agent 1 can signal to the host interface that its output buffer is empty. The runtime software can assert a suspend input command to agent 2. Agent 2 can be fully resident 544 prior to the suspend signal. The output buffer 542 from agent 1 is the input buffer to agent 2. Since the input buffer to agent 2 is empty, agent 2 can issue a signal such as a semaphore, flag, and so on, back to the host. The signal, such as a semaphore back from agent 2 to the host, can indicate that agent 2 is in a partially resident state. The agent 2 output buffer 546 can contain data which can be used as input data to other downstream agents. The downstream agents can drain the data in output buffer 546.

FIG. 5C is an example illustrating agent 2 partially resident 504. The figure continues the progression of swapping out a subgraph. Following receipt of a suspend signal, agent 2 can become partially resident. The output buffers of a pipeline of agents can drain. A first fully resident agent 550 provides data to and controls output buffer 554. Similarly, a second fully resident agent 552 provides data to and controls output buffer 556. Buffers 554 and 556 can contain data and can serve as the input buffers to partially resident agent 1 560. What data may remain in buffer 562, the output buffer of partially resident agent 1, and the input buffer of partially resident agent 2 564, can be drained by agent 2. Agent 2 can continue processing the remaining data in buffer 562 until the data is drained. Agents downstream of agent 2 can process data in the output buffer 566 of agent 2. The runtime software can wait for the second agent to signal that the one or more output buffers 566 are empty. When the output buffer of agent 2 has been drained, agent 2 can be eligible for vacating.

FIG. 5D is an example illustrating a swapped-out subgraph 506. Upon receiving a signal from a second agent that the output buffer of the second agent has been drained, runtime software can remove a control unit of agent 2. A first fully resident agent 570 can provide data to and maintain control of output buffer 574. A second fully resident agent 572 can provide data to and control output buffer 576. Agent 1 can be partially resident 580. Agent 1 may not be processing data nor draining data from the buffers 574 and 576 as it awaits draining of its output buffer 582 by agent 2. Agent 2 processes any remaining data in output buffer 582 until the buffer is fully drained. The runtime software can remove the control unit for agent 2. Agent 2 can be fully vacant 584, since both the agent 2 kernel and the agent 2 control unit have been removed. The output buffer 586 has been drained by any downstream agents that remain resident or partially resident. With agent 2 fully vacant, agent 1 can remain tracking incoming data, such as tensor data, at its input buffers, which are output buffers 574 and 576. The agent 1 kernel can be restored and processing can resume.

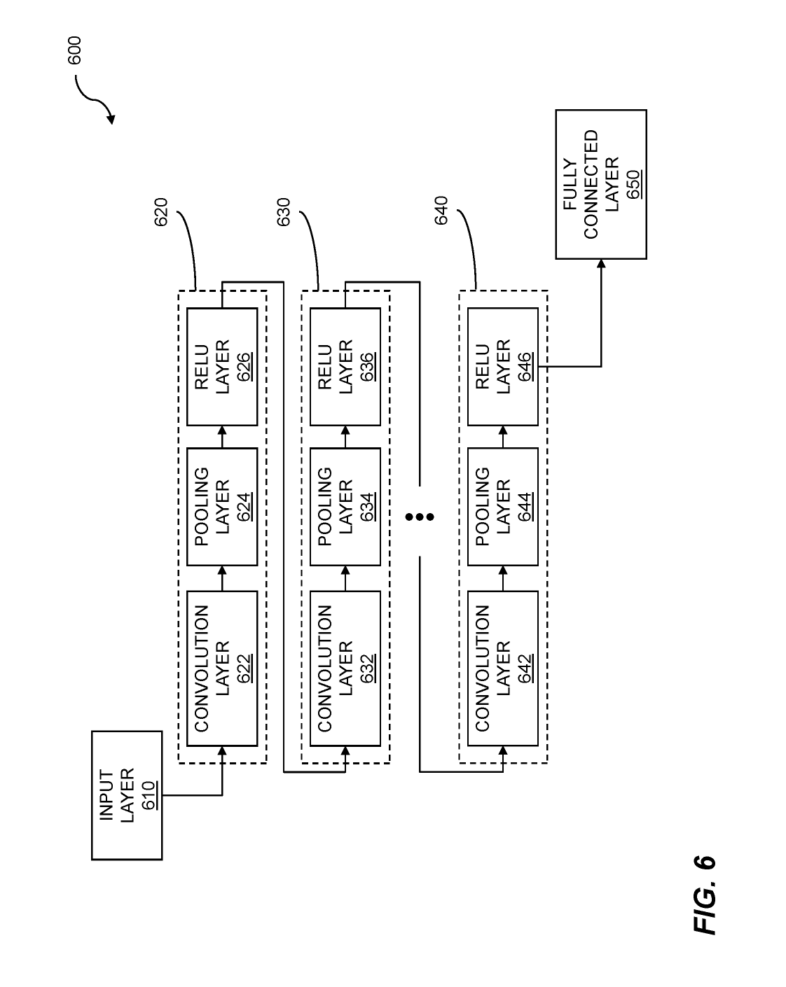

FIG. 6 shows a deep learning block diagram. The deep learning block diagram 600 can include a neural network such as a deep neural network (DNN), a convolutional neural network, and so on. A convolutional neural network can be based on layers, where the layers can include input layers, output layers, fully connected layers, convolution layers, pooling layers, rectified linear unit (ReLU) layers, and so on. The layers of the convolutional network can be implemented using a reconfigurable fabric. The reconfigurable fabric can include processing elements, switching elements, storage elements, etc. The reconfigurable fabric can be used to perform logical operations based on agents, where the agents can include an agent control unit and an agent kernel. Deep learning can be applied to dynamic reconfiguration with partially resident agents.

A deep learning block diagram 600 is shown. The block diagram can include various layers, where the layers can include an input layer, hidden layers, a fully connected layer, and so on. In some embodiments, the deep learning block diagram can include a classification layer. The input layer 610 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 600, which can represent a network such as a convolutional neural network, can contain a plurality of hidden layers. While three hidden layers, 620, 630, and 640, are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 620 can include convolution layer 622, pooling layer 624, and ReLU layer 626; layer 630 can include convolution layer 632, pooling layer 634, and ReLU layer 636; and layer 640 can include convolution layer 642, pooling layer 644, and ReLU layer 646. The convolution layers 622, 632, and 642 can perform convolution operations; the pooling layers 624, 634, and 644 can perform pooling operations, including max pooling, such as data down-sampling; and the ReLU layers 626, 636, and 646 can perform rectification operations. A convolutional layer can reduce the amount of data feeding into a fully connected layer. The deep learning block diagram 600 can include a fully connected layer 650. The fully connected layer can be connected to each data point from the one or more convolutional layers.

Data flow processors can be implemented within a reconfigurable fabric. Data flow processors can be used in many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs organized in arrangements such as quads can be coupled to arithmetic units, where the arithmetic units can be coupled to or included in data processing units (DPU). The DPUs can be shared between and among quads. The DPUs can provide arithmetic techniques to the PEs, communications between and among quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value (−1)+the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were preprogrammed to enter into configuration mode can be preprogrammed to exit configuration mode. When configuration mode has been exited, execution of the one or more kernels loaded onto the clusters can commence.

Data flow processes that can be executed by a data flow processor can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit (SDK) can be in an agent library. The agent source code can be created using a variety of tools, where the tools can include MATMUL™, Batchnorm™, Relu™ and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

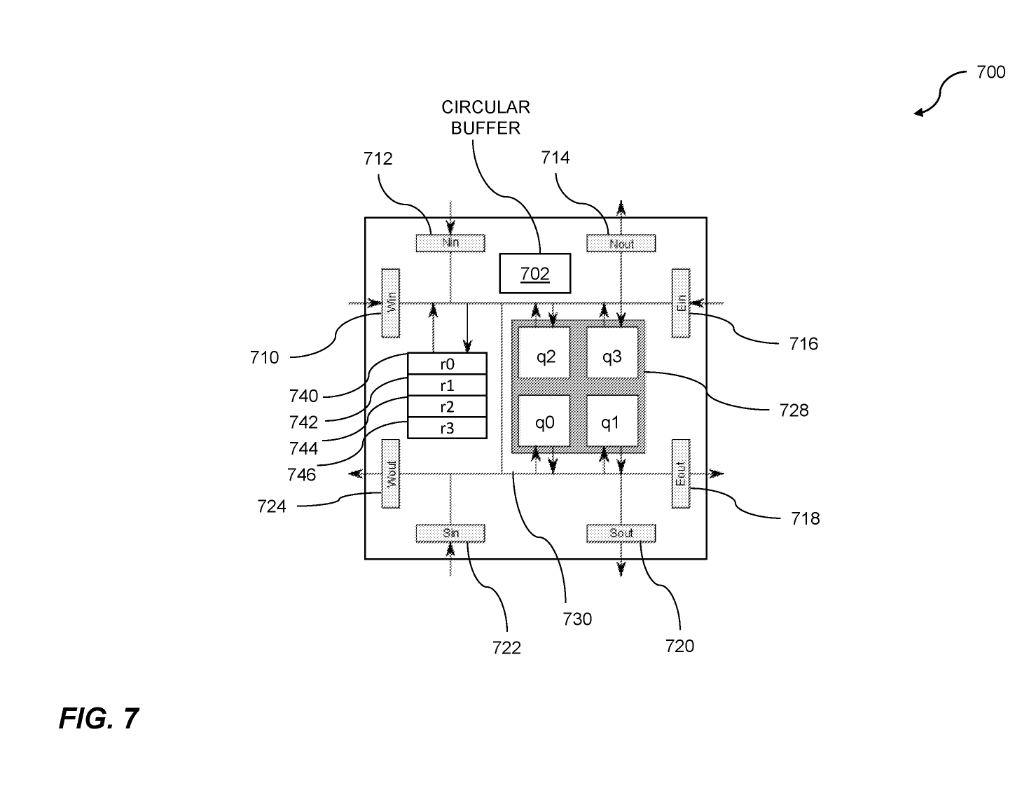

FIG. 7 shows a cluster for coarse-grained reconfigurable processing. The cluster for coarse-grained reconfigurable processing 700 can be used for dynamic reconfiguration with partially resident agents. Data to be processed can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The cluster 700 comprises a circular buffer 702. The circular buffer 702 can be referred to as a main circular buffer or a switch-instruction circular buffer. In some embodiments, the cluster 700 comprises additional circular buffers corresponding to processing elements within the cluster. The additional circular buffers can be referred to as processor instruction circular buffers. The example cluster 700 comprises a plurality of logical elements, configurable connections between the logical elements, and a circular buffer 702 controlling the configurable connections. The logical elements can further comprise one or more of switching elements, processing elements, or storage elements. The example cluster 700 also comprises four processing elements—q0, q1, q2, and q3. The four processing elements can collectively be referred to as a “quad,” and are jointly indicated by a grey reference box 728. In embodiments, there is intercommunication among and between each of the four processing elements. In embodiments, the circular buffer 702 controls the passing of data to the quad of processing elements 728 through switching elements. In embodiments, the four processing elements 728 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 700 can further comprise storage elements coupled to the configurable connections. As shown, the cluster 700 comprises four storage elements—r0 740, r1 742, r2 744, and r3 746. The cluster 700 further comprises a north input (Nin) 712, a north output (Nout) 714, an east input (Ein) 716, an east output (Eout) 718, a south input (Sin) 722, a south output (Sout) 720, a west input (Win) 710, and a west output (Wout) 724. The circular buffer 702 can contain switch instructions that implement configurable connections. For example, an instruction effectively connects the west input 710 with the north output 714 and the east output 718 and this routing is accomplished via bus 730. The cluster 700 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 702. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 724 to an instruction placing data on the south output 720, such that the data can be output on both output ports within the same pipeline cycle. In a case where data needs to travel to a cluster that is both south and west of the cluster 700, it can be more efficient to send the data directly to the south output port rather than to store the data in a register first, and then send the data to the west output on a subsequent pipeline cycle.

An L2 switch interacts with the instruction set. A switch instruction typically has a source and a destination. Data is accepted from the source and sent to the destination. There are several sources (e.g. any of the quads within a cluster, any of the L2 directions (North, East, South, West), a switch register, one of the quad RAMs (data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A” to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing access to them to be shared by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

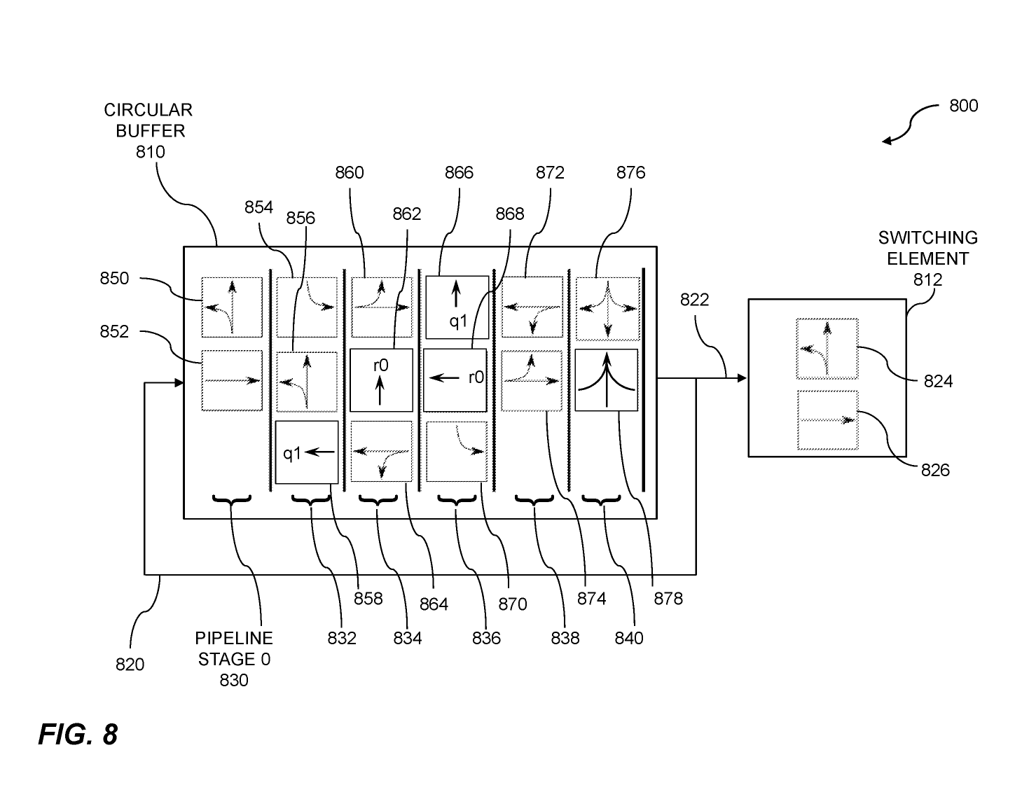

FIG. 8 illustrates a block diagram 800 of a circular buffer. The circular buffer of block diagram 800 can include a switching element 812 corresponding to the circular buffer 810. The circular buffer and the corresponding switching element can be used in part for pipelined tensor manipulation within a reconfigurable fabric. Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 800 describes a processor-implemented method for data manipulation. The circular buffer 810 contains a plurality of pipeline stages. Each pipeline stage contains one or more instructions, up to a maximum instruction depth. In the embodiment shown in FIG. 8, the circular buffer 810 is a 6×3 circular buffer, meaning that it implements a six-stage pipeline with an instruction depth of up to three instructions per stage (column). Hence, the circular buffer 810 can include one, two, or three switch instruction entries per column. In some embodiments, the plurality of switch instructions per cycle can comprise two or three switch instructions per cycle. However, in certain embodiments, the circular buffer 810 supports only a single switch instruction in a given cycle. In the example block diagram 800 shown, pipeline stage 0 830 has an instruction depth of two instructions 850 and 852. Though the remaining pipeline stages 1-5 are not textually labeled in the example block diagram 800, the stages are indicated by callouts 832, 834, 836, 838, and 840. Pipeline stage 1 832 has an instruction depth of three instructions 854, 856, and 858. Pipeline stage 2 834 has an instruction depth of three instructions 860, 862, and 864. Pipeline stage 3 836 also has an instruction depth of three instructions 866, 868, and 870. Pipeline stage 4 838 has an instruction depth of two instructions 872 and 874. Pipeline stage 5 840 has an instruction depth of two instructions 876 and 878. In embodiments, the circular buffer 810 includes 64 columns. During operation, the circular buffer 810 rotates through configuration instructions. The circular buffer 810 can dynamically change operation of the logical elements based on the rotation of the circular buffer. The circular buffer 810 can comprise a plurality of switch instructions per cycle for the configurable connections.

The instruction 852 is an example of a switch instruction. In embodiments, each cluster has four inputs and four outputs, each designated within the cluster's nomenclature as “north,” “east,” “south,” and “west” respectively. For example, the instruction 852 in the diagram 800 is a west-to-east transfer instruction. The instruction 852 directs the cluster to take data on its west input and send out the data on its east output. In another example of data routing, the instruction 850 is a fan-out instruction. The instruction 850 instructs the cluster to take data from its south input and send out on the data through both its north output and its west output. The arrows within each instruction box indicate the source and destination of the data. The instruction 878 is an example of a fan-in instruction. The instruction 878 takes data from the west, south, and east inputs and sends out the data on the north output. Therefore, the configurable connections can be considered to be time multiplexed.

In embodiments, the clusters implement multiple storage elements in the form of registers. In the example 800 shown, the instruction 862 is a local storage instruction. The instruction 862 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 858 is a processing instruction. The instruction 858 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 800 shown, the circular buffer 810 rotates instructions in each pipeline stage into switching element 812 via a forward data path 822, and also back to a pipeline stage 0 830 via a feedback data path 820. Instructions can include switching instructions, storage instructions, and processing instructions, among others. The feedback data path 820 can allow instructions within the switching element 812 to be transferred back to the circular buffer. Hence, the instructions 824 and 826 in the switching element 812 can also be transferred back to pipeline stage 0 as the instructions 850 and 852. In addition to the instructions depicted on FIG. 8, a no-op instruction can also be inserted into a pipeline stage. In embodiments, a no-op instruction causes execution to not be performed for a given cycle. In effect, the introduction of a no-op instruction can cause a column within the circular buffer 810 to be skipped in a cycle. By contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs causing the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 858, assuming that the processor q1 was previously in a sleep state. In embodiments, when the instruction 858 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 866. In the case of the instruction 866, data from the processor q1 is moved to the north output. In some embodiments, if Xs have been placed into the processor q1, such as during the instruction 858, then Xs would be retrieved from the processor q1 during the execution of the instruction 866 and applied to the north output of the instruction 866.

A collision occurs if multiple instructions route data to a particular port in a given pipeline stage. For example, if instructions 852 and 854 are in the same pipeline stage, they will both send data to the east output at the same time, thus causing a collision since neither instruction is part of a time-multiplexed fan-in instruction (such as the instruction 878). To avoid potential collisions, certain embodiments use pre-processing, such as by a compiler, to arrange the instructions in such a way that there are no collisions when the instructions are loaded into the circular buffer. Thus, the circular buffer 810 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 862), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0 and will thereby prevent a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

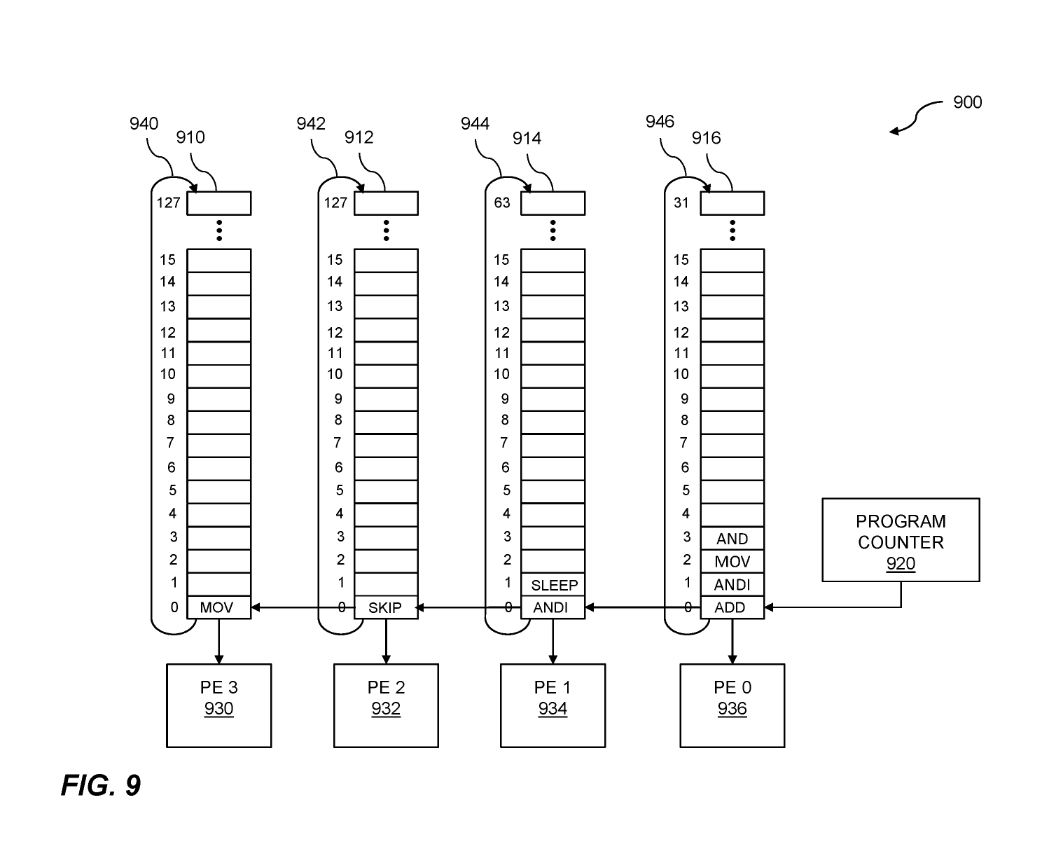

FIG. 9 illustrates a circular buffer and processing elements. The figure shows a diagram 900 indicating example instruction execution for processing elements. The instruction execution can include instructions for tensor radix point calculation in a neural network. A circular buffer 910 feeds a processing element 930. A second circular buffer 912 feeds another processing element 932. A third circular buffer 914 feeds another processing element 934. A fourth circular buffer 916 feeds another processing element 936. These circular buffers are shown with lengths of 128, 64, and 32 entries, but various lengths are possible. The four processing elements 930, 932, 934, and 936 can represent a quad of processing elements. In embodiments, the processing elements 930, 932, 934, and 936 are controlled by instructions received from the circular buffers 910, 912, 914, and 916. The circular buffers can be implemented using feedback paths 940, 942, 944, and 946, respectively. In embodiments, the circular buffer can control the passing of data to a quad of processing elements through switching elements, where each of the quad of processing elements is controlled by four other circular buffers (as shown in the circular buffers 910, 912, 914, and 916) and where data is passed back through the switching elements from the quad of processing elements where the switching elements are again controlled by the main circular buffer. In embodiments, a program counter 920 is configured to point to the current instruction within a circular buffer. In embodiments with a configured program counter, the contents of the circular buffer are not shifted or copied to new locations on each instruction cycle. Rather, the program counter 920 is incremented in each cycle to point to a new location in the circular buffer. The circular buffers 910, 912, 914, and 916 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 910 and 912 have a length of 128 instructions, the circular buffer 914 has a length of 64 instructions, and the circular buffer 916 has a length of 32 instructions, but other circular buffer lengths are also possible. In some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 9, different circular buffers can have different instruction sets within them. For example, the first circular buffer 910 contains a MOV instruction. The second circular buffer 912 contains a SKIP instruction. The third circular buffer 914 contains a SLEEP instruction and an ANDI instruction. The fourth circular buffer 916 contains an AND instruction, a MOVE instruction, an ANDI instruction, and an ADD instruction. The operations performed by the processing elements 930, 932, 934, and 936 are dynamic and can change over time, based on the instructions loaded into the respective circular buffers. As the circular buffers rotate, new instructions can be executed by the respective processing element.

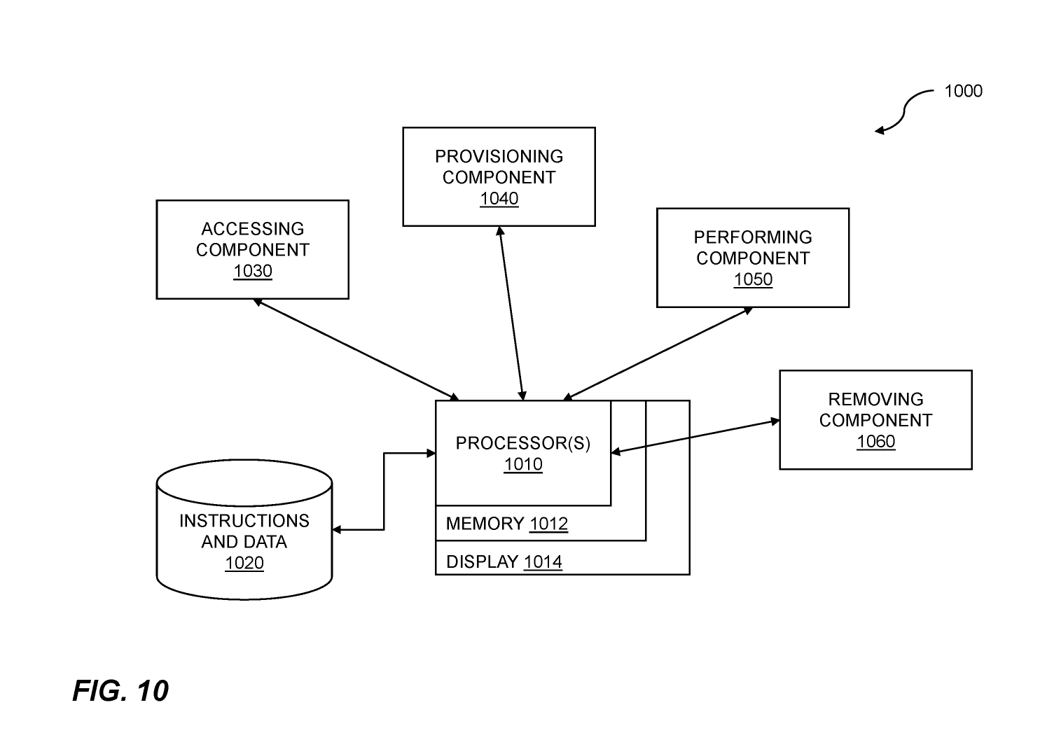

FIG. 10 is a system for dynamic reconfiguration of data flow agents. The system 1000 can include one or more processors 1010 coupled to a memory 1012 which stores instructions. The system 1000 can include a display 1014 coupled to the one or more processors 1010 for displaying data, intermediate steps, instructions, and so on. In embodiments, one or more processors 1010 are attached to the memory 1012 where the one or more processors, when executing the instructions which are stored, are configured to: access a plurality of clusters on a reconfigurable fabric to implement a logical operation; provision two or more clusters from the plurality of clusters for implementation of a first agent on the reconfigurable fabric wherein the first agent is comprised of an agent control unit and an agent kernel; execute, on the two or more clusters of the reconfigurable fabric, the logical operation using the first agent; and remove the agent kernel from the reconfigurable fabric while leaving the agent control unit resident on the reconfigurable fabric. The system 1000 can include a collection of instructions and data 1020. The instructions and data 1020 may be stored in a database, one or more statically linked libraries, one or more dynamically linked libraries, precompiled headers, source code, flow graphs, kernels, agents, or other suitable formats. The instructions can include instructions for dynamic reconfiguration with partially resident agents. The instructions can include a static schedule for controlling a rotating circular buffer.

The system 1000 can include an accessing component 1030. The accessing component 1030 can include functions and instructions for accessing a plurality of clusters on a reconfigurable fabric to implement a logical operation. The reconfigurable fabric is comprised of a plurality of processing elements, storage elements, and switching elements. The logical operation can include a Boolean operation such as AND, OR, NAND, NOR, XOR, XNOR, and so on. The system 1000 can include a provisioning component 1040. The provisioning component 1040 can include functions and instructions for provisioning two or more clusters from the plurality of clusters for implementation of a first agent on the reconfigurable fabric wherein the first agent is comprised of an agent control unit and an agent kernel.

The system 1000 can include a performing component 1050. The performing component 1050 can include functions and instructions for executing the logical operation using the first agent. The logical operation such as a Boolean operation can be executed on the two or more clusters of elements on the reconfigurable fabric. The system 1000 can include a removing component 1060. The removing component can include functions and instructions for removing the agent kernel from the reconfigurable fabric while leaving the agent control unit resident on the reconfigurable fabric. In embodiments, the agent control unit can be used to buffer data incoming to the first agent. The agent control unit can be used to buffer input data and output data. The first agent can buffer data from a second agent that provides the incoming data to the first agent. The control unit for the first agent can be used for other purposes. In embodiments, the agent control unit is used to provide data to logic downstream from the first agent. The data can be stored using a variety of techniques including structures, linked lists, and the like. The agent control unit can maintain the data structures or other data storage techniques within the reconfigurable fabric. The agent can be fully resident or partially resident. In embodiments, having the agent control unit and the agent kernel resident comprises having the agent fully resident. As noted above, the agent kernel can be removed. In embodiments, having the agent control unit resident after the agent kernel is removed comprises having the agent partially resident. The agent control unit and the agent kernel can be removed from the reconfigurable fabric. Removal of the agent control unit may only occur when input buffers and output buffers are empty. In embodiments, the removing the agent control unit resident as well as having the agent kernel removed comprises having the agent fully vacant. A further agent, including an agent control unit and an agent kernel, can be loaded using space vacated by the removing the agent kernel. The agents that are loaded and removed can be based on a data flow graph, where the data flow graph includes subgraphs. A subgraph can be restored into a location of the reconfigurable fabric which is different from a prior location provisioned for the subgraph.

The system 1000 can include a computer program product embodied in a non-transitory computer readable medium for calculation, the computer program product comprising code which causes one or more processors to perform operations of: accessing a plurality of clusters on a reconfigurable fabric to implement a logical operation; provisioning two or more clusters from the plurality of clusters for implementation of a first agent on the reconfigurable fabric wherein the first agent is comprised of an agent control unit and an agent kernel; executing, on the two or more clusters of the reconfigurable fabric, the logical operation using the first agent; and removing the agent kernel from the reconfigurable fabric while leaving the agent control unit resident on the reconfigurable fabric.

Some embodiments include a reconfigurable processing fabric comprising: a first processing cluster; and a second processing cluster coupled reconfigurably to the first processing cluster to provide a reconfigurable processing fabric for implementing a logical operation, wherein the logical operation is implemented by the reconfigurable processing fabric, wherein the first processing cluster and the second processing cluster implement a first agent comprising an agent control unit and an agent kernel, and wherein the logical operation is performed using the first agent, whereby the agent kernel is removed from the reconfigurable processing fabric while the agent control unit remains in the reconfigurable processing fabric.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for calculation comprising:
accessing a plurality of clusters on a reconfigurable fabric to implement a logical operation;
provisioning two or more clusters from the plurality of clusters for implementation of a first agent on the reconfigurable fabric wherein the first agent is comprised of an agent control unit and an agent kernel;
executing, on the two or more clusters of the reconfigurable fabric, the logical operation using the first agent; and
removing the agent kernel from the reconfigurable fabric while leaving the agent control unit resident on the reconfigurable fabric.

2. The method of claim 1 further comprising using the agent control unit to buffer data incoming to the first agent.

3. The method of claim 2 wherein a second agent provides the data incoming to the first agent.

4. The method of claim 3 further comprising removing a portion of the second agent.

5. The method of claim 1 further comprising using the agent control unit to provide data to logic downstream from the first agent.

6. The method of claim 5 wherein a third agent is included in the logic downstream from the first agent.

7. The method of claim 6 further comprising removing a portion of the third agent.

8. The method of claim 1 wherein the agent control unit maintains data structures within the reconfigurable fabric.

9-10. (canceled)

11. The method of claim 1 wherein the reconfigurable fabric comprises a plurality of circular buffers.

12. The method of claim 11 wherein the plurality of circular buffers is statically scheduled.

13. The method of claim 1 wherein having the agent control unit resident after the agent kernel is removed comprises having the agent partially resident.

14. The method of claim 1 wherein having the agent control unit and the agent kernel resident comprises having the agent fully resident.

15. The method of claim 1 further comprising removing the agent control unit from the reconfigurable fabric.

16. The method of claim 15 wherein the removing the agent control unit resident as well as having the agent kernel removed comprises having the agent fully vacant.

17. The method of claim 15 wherein the removing the agent control unit only occurs once output buffers from the first agent are empty.

18. The method of claim 17 wherein the removing the agent control unit only occurs once input buffers to the first agent are empty.

19. The method of claim 18 wherein the input buffers and the output buffers comprise FIFOs.

20. The method of claim 1 wherein the first agent is part of a data flow graph implemented with the reconfigurable fabric.

21. The method of claim 20 wherein the data flow graph is larger than the reconfigurable fabric is configurable for in a single loading.

22. The method of claim 21 further comprising loading a further agent using space vacated by the removing the agent kernel.

23. The method of claim 22 wherein the further agent is part of the data flow graph.

24. The method of claim 20 wherein the removing the agent kernel is part of swapping out a subgraph that is part of the data flow graph.

25. The method of claim 24 further comprising restoring the subgraph into the reconfigurable fabric.

26. The method of claim 25 wherein the restoring places the subgraph into a different location in the reconfigurable fabric than previously occupied by the subgraph prior to the swapping out of the subgraph.

27. A computer program product embodied in a non-transitory computer readable medium for calculation, the computer program product comprising code which causes one or more processors to perform operations of:
accessing a plurality of clusters on a reconfigurable fabric to implement a logical operation;
provisioning two or more clusters from the plurality of clusters for implementation of a first agent on the reconfigurable fabric wherein the first agent is comprised of an agent control unit and an agent kernel;
executing, on the two or more clusters of the reconfigurable fabric, the logical operation using the first agent; and
removing the agent kernel from the reconfigurable fabric while leaving the agent control unit resident on the reconfigurable fabric.

28. (canceled)

29. A reconfigurable processing fabric comprising:
a first processing cluster; and
a second processing cluster coupled reconfigurably to the first processing cluster to provide a reconfigurable processing fabric for implementing a logical operation, wherein the logical operation is implemented by the reconfigurable processing fabric, wherein the first processing cluster and the second processing cluster implement a first agent comprising an agent control unit and an agent kernel, and wherein the logical operation is performed using the first agent, whereby the agent kernel is removed from the reconfigurable processing fabric while the agent control unit remains in the reconfigurable processing fabric.
